(19) United States
(12) Patent Application Publication
(10) Pub. No.: US 2007/0244015 A1
(43) Pub. Date: Oct. 18, 2007

(54) Use of Glycols and Polyols to Stabilize Viscoelastic Surfactant Gelled Fluids

(75) Inventors: James B. Crews, Willis, TX (US); John R. Willingham, Cypress, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/696,840

(22) Filed: Apr. 5, 2007

Related U.S. Application Data
(60) Provisional application No. 60/791,025, filed on Apr. 11, 2006.

(51) Int. Cl. C09K 8/80

(52) U.S. Cl. 507/266

(57) ABSTRACT

The increased viscosity of aqueous fluids gelled with viscoelastic surfactants (VESs) may be maintained or stabilized by one or more stabilizers added or introduced thereto. The stabilizers are glycols and/or polyols and may stabilize the increased viscosity of VES-gelled fluids effectively over an increased temperature range, e.g. up to 300° F. (149° C.). Even though some VESs used to increase the viscosity of aqueous fluids contain a glycol solvent, the use, addition or introduction of the same or different glycol or a polyol, possibly of increased purity, may improve the viscosity stability of the fluid as a whole.

### CROSS-REFERENCE TO RELATED APPLICATION

This application claims the benefit of U.S. Provisional Patent Application No. 60/791,025 filed Apr. 11, 2006.

### TECHNICAL FIELD

The present invention relates to aqueous gelled fluids, in one non-limiting embodiment aqueous gelled treatment fluids used during hydrocarbon recovery operations. The invention more particularly relates, in another non-restrictive embodiment, to methods of stabilizing or maintaining the increased viscosity or gel of the aqueous fluids that is provided by viscoelastic surfactant gelling agents.

### BACKGROUND

One of the primary methods for well stimulation in the production of hydrocarbons is hydraulic fracturing. Hydraulic fracturing is a method of using pump rate and hydraulic pressure to fracture or crack a subterranean formation. Once the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The development of suitable fracturing fluids is a complex art because the fluids must simultaneously meet a number of conditions. For example, they must be stable at high temperatures and/or high pump rates and shear rates that can cause the fluids to degrade and prematurely settle out the proppant before the fracturing operation is complete. Stability requires that the fluid maintains its viscosity sufficiently to complete the operation over the time and temperatures required. Stability also involves the component parts of the fluid not appreciably separating from one another over the temperatures and time periods involved. Various fluids have been developed, but most commercially used fracturing fluids are aqueous based liquids that have either been gelled or foamed. When the fluids are gelled, typically a polymeric gelling agent, such as a solvatable polysaccharide, for example guar and derivatized guar polysaccharides, is used. The thickened or gelled fluid helps keep the proppants within the fluid. Gelling can be accomplished or improved by the use of crosslinking agents or crosslinkers that promote crosslinking of the polymers together, thereby increasing the viscosity of the fluid. One of the more common crosslinked polymeric fluids is borate crosslinked guar.

The recovery of fracturing fluids may be accomplished by reducing the viscosity of the fluid to a low value so that it may flow naturally from the formation under the influence of formation fluids. Crosslinked gels generally require viscosity breakers to be injected to reduce the viscosity or “break” the gel. Enzymes, oxidizers, and acids are known polymer viscosity breakers. Enzymes are effective within a pH range, typically a 2.0 to 10.0 range, with increasing activity as the pH is lowered towards neutral from a pH of 10.0. Most conventional borate crosslinked fracturing fluids and breakers are designed from a fixed high crosslinked fluid pH value at ambient temperature and/or reservoir temperature. Optimizing the pH for a borate crosslinked gel is important to achieve proper crosslink stability and controlled enzyme breaker activity.

While polymers have been used in the past as gelling agents in fracturing fluids to carry or suspend solid particles as noted, such polymers require separate breaker compositions to be injected to reduce the viscosity. Further, such polymers tend to leave a coating on the proppant and a filter cake of dehydrated polymer on the fracture face even after the gelled fluid is broken. The coating and/or the filter cake may interfere with the functioning of the proppant. Studies have also shown that “fish-eyes” and/or “microgels” present in some polymer gelled carrier fluids will plug pore throats, leading to impaired leakoff and causing formation damage.

Recently it has been discovered that aqueous drilling and treating fluids may be gelled or have their viscosity increased by the use of non-polymeric viscoelastic surfactants (VES). These VES materials are advantageous over the use of polymer gelling agents, since they are low molecular weight surfactants, in that they are less damaging to the formation, without a fluid-loss additive present leave no filter cake on the formation face, leave very little coating on the proppant, and do not create microgels or “fish-eyes”. VES-gelled fluids are an improvement over polymer-gelled fluids from the perspective of being easier to clean up the residual gel materials after the fluid viscosity is broken and the fluid produced or flowed back.

Methods for controlling the rheology of aqueous systems, particularly for those intended for underground use, that include injecting an aqueous viscoelastic fluid containing a surfactant gelling agent into the system are known, where the VES composition includes, as a gelling agent, at least one fatty aliphatic amidoamine oxide in a glycol solvent.

Occasionally VES-gelled aqueous fluids undesirably rapidly lose their increased viscosity or cannot maintain the necessary viscosity particularly when subjected to certain conditions, such as brine (when salts are used to increase the density of the fluid) and/or high or elevated temperatures.

It would be desirable if methods and components could be devised to stabilize aqueous fluids gelled with and composed of viscoelastic surfactants, particularly at elevate temperatures.

### SUMMARY

There is provided, in one non-limiting embodiment, a method for stabilizing an aqueous fluid gelled with a viscoelastic surfactant (VES), where the method involves combining in any order: water, a VES in an amount effective to increase the viscosity of the fluid, and a stabilizer. The stabilizer may be one or more glycol(s) and/or polyol(s), and the stabilizer is present in an amount effective to substantially maintain an increased viscosity of the water gelled with VES. The VES may or may not contain a glycol solvent. It will be appreciated that it is not necessary for the method to be considered successful for the maximum viscosity of the fluid to be maintained indefinitely; it is acceptable for the viscosity to decline or decrease slowly over time and/or temperature, but sufficient or substantial viscosity should be sustained over the time and temperatures necessary to complete the task, in one non-limiting embodiment—fracturing a subterranean formation and placing proppant in the consequent fractures.

There is also provided in a non-limiting, alternative embodiment, a method for stabilizing an aqueous fluid gelled with a viscoelastic surfactant (VES), where the method involves providing the gelled aqueous fluid, where the fluid includes water and a VES in an amount effective to increase the viscosity of the fluid, where the VES comprises a glycol solvent. The method further involves adding a stabilizer to the gelled aqueous fluid that is one or more glycol and/or polyol, where the stabilizer is present in an amount effective to substantially maintain the increased viscosity of the water gelled with the VES.

In another non-restrictive version, there is provided a gelled, stabilized aqueous fluid that includes water; a viscoelastic surfactant (VES) in an amount effective to increase the viscosity of the water, and a stabilizer. Again, the stabilizer may be one or more glycols and/or polyols, where the stabilizer is present in an amount effective to substantially maintain the increased viscosity of the fluid.

### BRIEF DESCRIPTION OF THE DRAWINGS

FIG. 1 is a graph of viscosity as a function of time at 250° F. (121° C.) for aqueous fluids gelled with a commercially available VES comparing a baseline or standard with other fluids gelled with the same VES that are not stable over the same time period and temperature;

FIG. 2 is a graph of viscosity as a function of time at 250° F. (121° C.) for aqueous fluids gelled with a commercially available VES comparing a baseline or standard with other fluids gelled with the same VES that are not stable over the same time period and temperature even though they contain free amine;

FIG. 3 is a graph of viscosity as a function of time at 250° F. (121° C.) for aqueous fluids gelled with a commercially available VES comparing a baseline or standard with other fluids gelled with the same VES that are improved in stability to various degrees over the same time period and temperature when they contain stabilizing amounts of glycols or polyols in accordance with the methods and additives herein;

FIG. 4 is a graph of viscosity as a function of time at 250° F. (121° C.) for an aqueous fluid gelled with a commercially available VES comparing fluid having no monopropylene glycol (MPG) added thereto showing a relatively rapid decrease in viscosity with two otherwise identical fluids containing differing levels of MPG showing improved stability; and

FIG. 5 is the FIG. 2 graph showing an additional curve representing the effect of adding 0.5% MPG to the formulation giving noticeably improved stability.

### DETAILED DESCRIPTION

While investigating high temperature performance of batch to batch productions of a particular amine oxide viscoelastic surfactant (VES), it was recent discovered that several batches of the surfactant showed no fluid viscosity upon heating the fluid to 250° F. (121° C.) in a 10.8 ppg (1.3 kg/liter) density CaCl₂ brine. This was potentially a major concern since previous work with a particular fracturing fluid using this VES showed stable viscosity up to about 300° F. (about 149° C.) even with the use of Baker Oil Tools' proprietary VES-STA 1 stabilizer. This stabilizer is not a glycol or polyol.

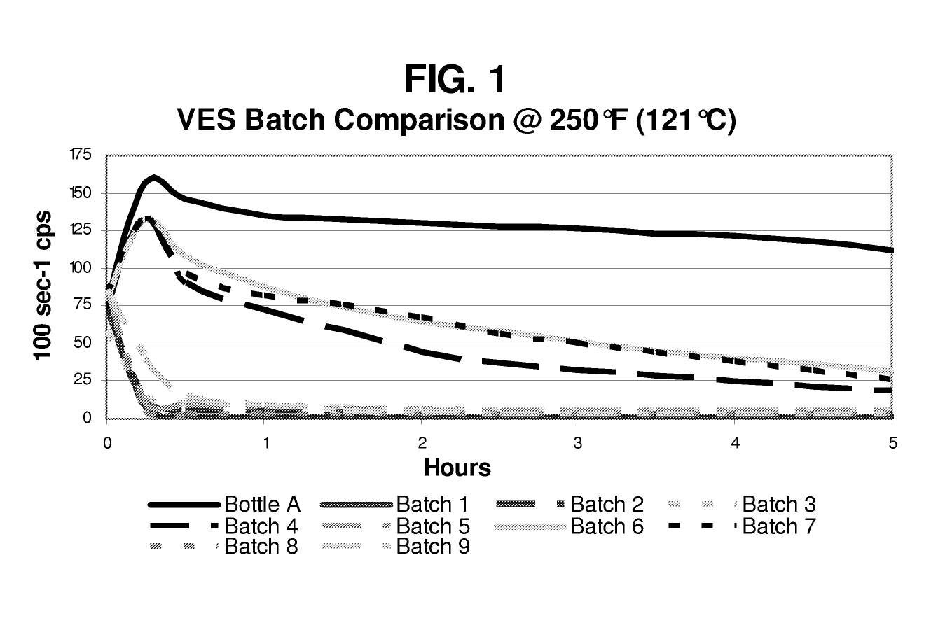

FIG. 1 shows a comparison of the viscosity of various batches of the amine oxide VES-gelled aqueous fluids as a function of time over 5 hours at 250° F. (121° C.). The fluid composition was 10.8 ppg (1.3 kg/liter) density CaCl₂ brine with 4% by volume (bv) of the VES and 2.0 pptg (0.24 kg/m³) of the VES-STA 1 stabilizer, except that for Batches 7, 8 and 9, an increased amount of 6.0 pptg (0.72 kg/m³) of the VES-STA 1 stabilizer was used. The viscosity testing was performed on a Grace 5500 rheometer at 250° F. (121° C.) with 300 psi (2.1 MPa) pressure and 100 sec⁻¹ shear.

Bottle A was a sample of the amine oxide VES from a time period one or two years before known to give satisfactory performance. Thus, Bottle A became the baseline for VES performance that was desired against which the various other VES samples were compared. It may be seen that after an initial spike in viscosity, the Bottle A material gave a relatively stable increased viscosity over the 5-hour time period. However, the VES materials of Batches 1-9 rapidly decreased in viscosity. Batches 4, 6, and 7 gave levels of intermediate viscosity but half or less than that of the Bottle A viscosity. Batches 8 and 9 were especially poor performers even though each had an increased level of the VES-STA 1 stabilizer. All fluids from Batches 1-9 shown in FIG. 1 had severe VES phase separation of the aqueous phase; the sample using the Bottle A material had no phase separation. For Batches 1-9 the viscosity decline was basically due to the VES phase separation of the brine fluid over time, and the fluid viscosity dropped accordingly. The VES phase separation for Batches 1, 2, 3, 5, 8 and 9 happened very quickly.

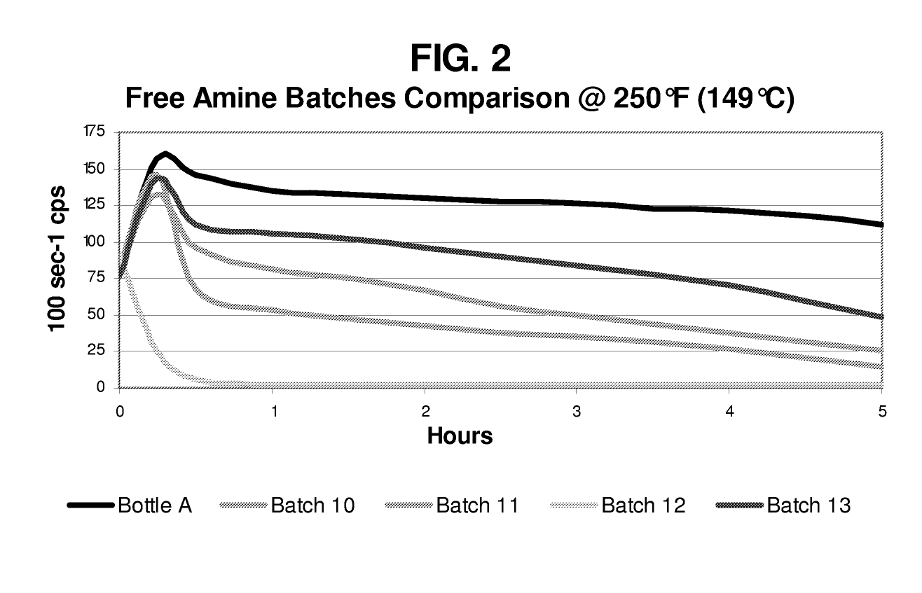

When the manufacturer of the amine oxide VES used in FIG. 1 was asked about the stability problem, its recommendation was that optimizing the free amine content within the amine oxide VES may correct the high temperature stability difficulty. The manufacturer sent samples with high free amine content and free fatty acid content within specification and the tests did show improvement in thermal stability as presented in FIG. 2. FIG. 2 shows a comparison of the viscosity of various batches of the amine oxide VES-gelled aqueous fluids as a function of time over 5 hours at 250° F. (121° C.). The fluid composition was 10.8 ppg (1.3 kg/liter) density CaCl₂ brine with 4% by volume (bv) of the VES and the increased amount of 6.0 pptg (0.24 kg/m³) of the VES-STA 1 stabilizer. The viscosity testing was performed as described above for FIG. 1. The Bottle A baseline still gave the best results of the 5 compositions, where Batch 12 showed a nearly immediate decrease in viscosity to 0. The use of free amine to aid the VES high temperature viscosity up to about 176° (about 80° C.) is taught by U.S. Pat. No. 6,506,710, column 8, line 61 to column 9, line 2. However, it appeared that some other potentially major chemical reason was the cause why instability at about 250° F. (about 121° C.) still occurred even with the free amine optimized, the free fatty acid content in specification, and the VES-STA 1 present at an increased level in the fluid as shown in FIG. 2.

It has subsequently been discovered that an important reason for the instability of the amine oxide VES-gelled fluids for which data is presented in FIGS. 1 and 2 may be the quality and/or type and/or amount of glycols and/or polyols that may be used to liquify the VES. This discovery provides a method to regain or obtain most to all of the needed and expected VES-gelled viscosity at elevated temperatures.

Suitable glycols for use with the stabilizing method herein include, but are not necessarily limited to, monoethylene glycol (MEG), diethylene glycol (DEG), triethylene glycol (TEG), tetraethylene glycol (TetraEG), monopropylene glycol (MPG), dipropylene glycol (DPG), and tripropylene glycol (TPG), and where the polyols include, but are not necessarily limited to, polyethylene glycol (PEG), polypropylene glycol (PPG), and glycerol and other sugar alcohols, and mixtures thereof. In the case where the stabilizer is a polyol, the molecular weight of the polyol may range from about 54 to about 370 weight average molecular weight, alternatively where the lower threshold is about 92 weight average molecular weight, and/or independently where the upper threshold is about 235 weight average molecular weight.

Any proportion of glycol or polyol stabilizer that is effective to improve or substantially maintain the viscosity of the VES-gelled fluid may be used, added or introduced to the aqueous VES-gelled fluid, and this proportion or amount may be determined empirically. In one non-limiting embodiment, by “substantially maintain the viscosity of the VES-gelled fluid” is meant that the viscosity is sufficient to achieve the purposes of the viscosified fluid, for instance fracturing a subterranean formation, placing a gravel pack, a diverting operation and the like. In most such operations and applications, the viscosity of the fluid is eventually desirably reduced so that it may be removed from the location or place where it was effective. In another non-restrictive version “substantially maintain the viscosity of the VES-gelled fluid” is defined as not decreasing more than 35% after the initial drop from peak viscosity (the point where viscosity begins to level off) over 5 hours; alternatively not decreasing more than 30% over 5 hours, and in another non-limiting embodiment not decreasing more than 20% over 5 hours.

In many, if not most, situations it may be difficult to specify in advance what an appropriate proportion or dosage range of stabilizer for a particular VES-gelled aqueous fluid should be since there are a number of inter-related factors that may affect this proportion including, but not necessarily limited to, the type and nature of the VES surfactant, the amount of the VES-surfactant in the aqueous fluid, the amount and nature of solvent in the VES, if any, the desired increased viscosity of the fluid, the length of time the viscosity of the fluid should be maintained, the temperature range over which the viscosity of the fluid should be maintained, the type of stabilizer(s) used, and the like. Nevertheless in order to give some idea of suitable proportions that may be used, introduced or added, in one non-limiting embodiment the stabilizer is added in a proportion ranging from about 0.1 to 10.0% by volume based on the total of the aqueous fluid. In an alternate, non-restrictive embodiment, the lower end of this proportion range may be about 0.2% bv, and independently or alternatively the upper end of this proportion range may be about 5.0% bv.

It will be appreciated that in one non-restrictive understanding of the method herein, the addition of extra stabilizer and the right type of stabilizer, such as MPG under certain conditions, may improve a poorly performing VES-gelled aqueous fluid. For a VES-gelled fluid where the VES already contains a glycol solvent, the addition of from about 0.1 to about 10.0 % bv additional stabilizer (whether or not the same type already present) improves the ability of the fluid to maintain viscosity. In another non-restrictive version at least from about 0.2% bv, up to alternatively or independently possibly at least about 5.0% bv.

Other components that may provide benefit for stabilizing or helping stabilize VES-gelled aqueous fluids potentially include, but are not necessarily limited to, alkylene carbonates, co-surfactants, hydrotropes and other solubilizers, and the like. These materials may be stabilizers per se, may be activators or synergists with the glycols and/or polyols described and discussed herein.

It is also believed that the purity of the glycol and/or polyol may play a role in its ability to stabilize the elevated viscosity of the VES-gelled fluid. If the glycol and/or polyol is contaminated with one or more materials that adversely affect the viscosity of the VES-gelled fluid, even small amounts of such a contaminant in a material or additive that otherwise would help stabilize the viscosity may be enough to disturb the elevated viscosity. Indeed, one non-limiting theory about how VES-gelled aqueous fluids may have their viscosity broken is by disturbing, degrading, or altering the VES micelle structure that gives the desired viscosity. In one non-restrictive instance, spherical micelles do not give increased viscosity whereas elongated or “worm-like” or “rod-like” micelles do provide the structure leading to increased viscosity, such as through their entanglement or other interaction. Thus, in one non-limiting embodiment the purity of the glycol and/or polyol stabilizer may be at least 95 volume %, and alternatively at least 99 vol %. In one non-limiting embodiment, it may be that a detrimental contaminant to a glycol stabilizer is a relatively high molecular weight polyglycol. These contaminant polyglycols may have weight average molecular weights of about 425 or more.

In another non-limiting embodiment, it is expected that the stabilizers herein may be optionally used in conjunction with or together with a solubilizing agent, e.g. solvent. Non-restrictive examples of optional solvents include but are not necessarily limited to glycol ether solvents (e.g. ethylene glycol monomethyl ether (EGMME), ethylene glycol monoethyl ether (EGMEE), ethylene glycol monopropyl ether (EGMPE), ethylene glycol monobutyl ether (EGMBE), ethylene glycol monomethyl ether acetate (EGMMEA), ethylene glycol monoethyl ether acetate (EGMEEA acetate) and the like). The solubilizing agent is expected to perform most or all of the following functions in a fracturing operation:
1. Help prevent emulsions between the VES fluid and the reservoir crude oil or other hydrocarbons.
2. Aid desorption of VES molecules from reservoir pore matrix minerals.
3. Aid lowering of surface tension between water-reservoir pore matrix minerals to:
   a. Aid treatment fluid recovery (flow-back) and
   b. Help prevent water block (due to high water absorption-saturation).

The present use of alkyl glycols, e.g. monopropylene glycol and diethylene glycol, appear to aid the solubility of amine oxide and possibly other VES surfactants at elevated temperatures. This is an effect that someone having ordinary skill in the art would not have expected at a temperature of about 250° F. (about 121° C.). It appears that at least amine oxide surfactants may lose water solubility as the fluid temperature increases, and the fluid reaches a point where a solubility aid agent (stabilizer) is beneficial, helpful or required to keep the amine oxide VES in the aqueous phase or else the surfactant will act like an oil and will phase separate out of the brine water as an “oil” layer on top of the brine water, although the inventors do not wish to be limited to any particular explanation. It appears the addition of the proper amount of monopropylene glycol, in one non-limiting embodiment, may be a good solubility aid for helping the VES-gelled fluid stay viscous and within the aqueous brine phase at high temperatures of from more than about ambient (about 72° F. or about 22° C.), alternatively from above 150° F. (about 66° C.), and in another non-restrictive embodiment from above 180° F. (about 83° C.) up to about 250° F. (about 121° C.), or even to about 300° F. (about 149° C.).

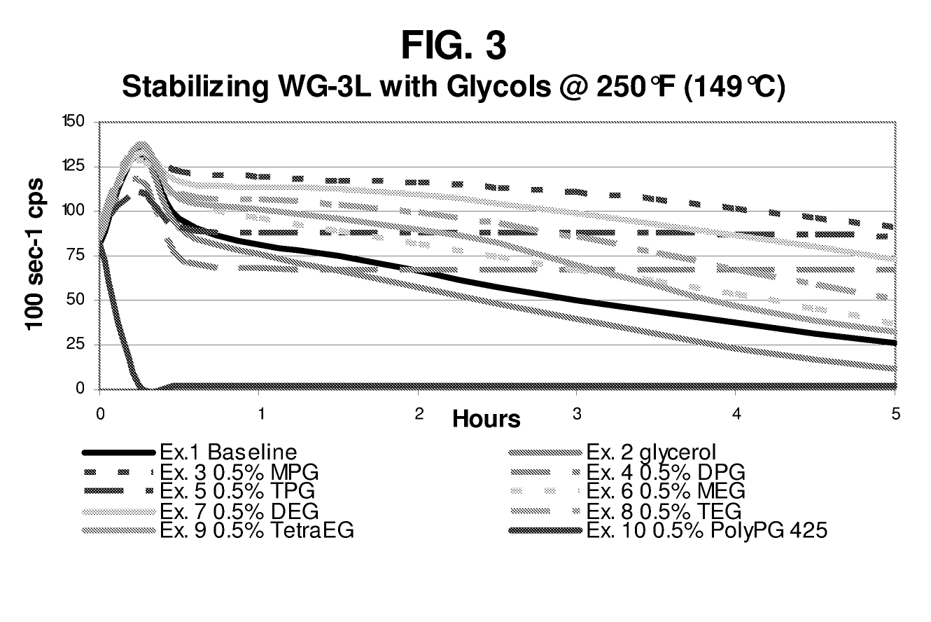

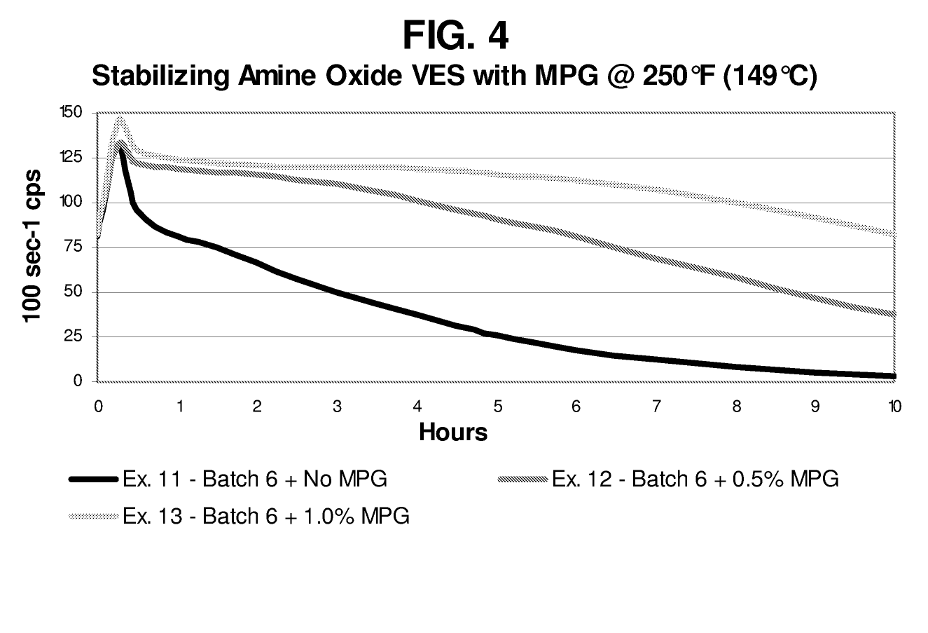

Overall, the glycols appear to be VES solubilizers or stabilizers, with the particular type, amount, and purity being important at elevated fluid temperatures (as represented in FIG. 3 and FIG. 4), such as about 200° F. (93° C.) and above. It may be possible that other polyols like sugar alcohols may work like alkyl glycols, but it is believed that alcohols like methanol and isopropanol will not work as high temp VES solubilizers that allow the VES fluid to retain its viscosity at these high fluid temperature. Additionally, it may be possible that alkyl carbonates, such as ethylene carbonate and propylene carbonate, may work like alkyl glycols as high temperature VES solubilizers that allow the VES fluid to retain its viscosity at these high fluid temperatures. It has been found that certain and select alkyl glycols give unexpected results as high temperature solubility enhancers to amine oxide and possibly other types of VES surfactants to at least about 300° F. (about 149° C.) and possibly higher temperatures. That is, these materials surprisingly can be used as high temperature VES solubilizers or stabilizers that are not detrimental to the VES fluid viscosity at types and amounts specified to practice this art, such as 0.5 to 1.0% bv monopropylene glycol, 0.5% diethylene glycol, and the like at about 250° F. (about 121° C.). Without the use of these materials and methods, the off-specification VES-gelled Batches 1-9 that were tested (FIG. 1) do not have stable viscosity and solubility at about 250° F. (about 121° C.), even with the use/presence of VES-STA 1 high temp VES stabilizer. Use of poor thermal stability batches of amine oxide product would result in catastrophic failure of fluids like Diamond FRAQ™ for high temperature frac-packs. Additionally, all Batches (except Bottle A) were found to phase separate out of the brine aqueous phase like an oil. It is surprising to find that the addition of select alkyl glycols will influence and give such high temperature solubility enhancement to a VES-gelled fluid.

The VES that is useful in the present invention can be any of the VES systems that are familiar to those in the well service industry, and may include, but are not limited to, amines, amine salts, quaternary ammonium salts, amidoamine oxides, amine oxides, mixtures thereof and the like. Suitable amines, amine salts, quaternary ammonium salts, amidoamine oxides, and other surfactants are described in U.S. Pat. Nos. 5,964,295; 5,979,555; 6,239,183; and 6,506,710 incorporated herein by reference.

Viscoelastic surfactants improve the fracturing (frac) fluid performance through the use of a polymer-free system. These systems offer improved viscosity breaking, higher sand transport capability, are more easily recovered after treatment, and are relatively non-damaging to the reservoir. The systems are also more easily mixed “on the fly” in field operations and do not require numerous co-additives in the fluid system, as do some prior systems.

The viscoelastic surfactants suitable for use in this invention may include, but are not necessarily limited to, non-ionic, cationic, amphoteric, and zwitterionic surfactants. Specific examples of zwitterionic/amphoteric surfactants include, but are not necessarily limited to, dihydroxyl alkyl glycinate, alkyl ampho acetate or propionate, alkyl betaine, alkyl amidopropyl betaine and alkylimino mono- or di-propionates derived from certain waxes, fats and oils. Quaternary amine surfactants are typically cationic, and the betaines are typically zwitterionic. The thickening agent may be used in conjunction with an inorganic water-soluble salt or organic additive such as phthalic acid, salicylic acid or their salts.

Some non-ionic fluids are inherently less damaging to the producing formations than cationic fluid types, and are more efficacious per pound than anionic gelling agents. Amine oxide viscoelastic surfactants have the potential to offer more gelling power per pound, making it less expensive than other fluids of this type.

The amine oxide gelling agents RN⁺ (R′)₂ O⁻ may have the following structure (I):

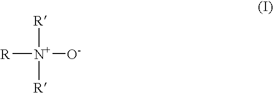

where R is an alkyl or alkylamido group averaging from about 8 to 24 carbon atoms and R′ are independently alkyl groups averaging from about 1 to 6 carbon atoms. In one non-limiting embodiment, R is an alkyl or alkylamido group averaging from about 8 to 16 carbon atoms and R′ are independently alkyl groups averaging from about 2 to 3 carbon atoms. In an alternate, non-restrictive embodiment, the amidoamine oxide gelling agent is Akzo Nobel's Aromox® APA-T formulation, which should be understood as a dipropylamine oxide since both R′ groups are propyl.

Materials sold under U.S. Pat. No. 5,964,295 include ClearFRAC™, which may also comprise greater than 10% of a glycol. One preferred VES is an amine oxide. As noted, a particularly preferred amine oxide is APA-T, sold by Baker Oil Tools as SurFRAQ™ VES. SurFRAQ™ is a VES liquid product that is about 50% APA-T and about 40% propylene glycol. These viscoelastic surfactants are capable of gelling aqueous solutions to form a gelled base fluid. The additives of this invention may also be used in Diamond FRAQ™ which is a VES system, similar to SurFRAQ™, sold by Baker Oil Tools.

The methods herein cover commonly known materials as Aromox® APA-T and WG-3L manufactured by Akzo Nobel and other known viscoelastic surfactant gelling agents common to stimulation treatment of subterranean formations.

The amount of VES included in the fracturing fluid depends on at least two factors. One involves generating enough viscosity to control the rate of fluid leak off into the pores of the fracture, and the second involves creating a viscosity high enough to keep the proppant particles suspended therein during the fluid injecting step, in the non-limiting case of a fracturing fluid. Thus, depending on the application, the VES is added to the aqueous fluid in concentrations ranging from about 0.5 to 25% by volume, alternatively up to about 12 vol % of the total aqueous fluid (from about 5 to 120 gallons per thousand gallons (gptg); SI equivalent volume units have the same value and may be expressed in any convenient terms, e.g. liters per thousand liters, m³/1000 m³, etc.). In another non-limiting embodiment, the range for the present invention is from about 1.0 to about 6.0% by volume VES product. In an alternate, non-restrictive form of the invention, the amount of VES ranges from 2 to about 10 volume %.

It is expected that the stabilizing compositions and methods mentioned above may be used to improve or stabilize the viscosity of a VES-gelled aqueous fluid regardless of how the VES-gelled fluid is ultimately utilized. For instance, the viscosity stabilizing compositions could be used in all VES applications including, but not limited to, VES-gelled friction reducers, VES viscosifiers for loss circulation pills, fracturing fluids and other stimulation fluids, fluid loss pills, drilling operations, gravel pack fluids, viscosifiers used as diverters in acidizing, VES viscosifiers used to clean up drilling mud filter cake, remedial clean-up of fluids after a VES treatment (post-VES treatment), and the like. It is also expected that the stabilizers discussed herein may be used when a fluid-loss additive is used within the VES-gelled fluid. Fluid-loss additives for VES fluids aid in lowering the fluid leak-off within the pores of a reservoir, in applications such as frac-packing. Non-limiting examples of fluid-loss additives are starches, calcium carbonate-starch mixtures, guar gum, gum acacia, alginates, biopolymers, polyglycolic acids, polylactic acids, mixtures thereof, and other additive the like. It is also expected that the stabilizers discussed herein may be used with internal VES breaking agents, such as mineral oils and polyenoic acids. It is further expected that the stabilizers discussed herein may be used with particles that associate VES micelles to promote viscosity enhancement and/or pseudo-filter cake fluid loss control, and the like.

In order to practice the methods herein, an aqueous fracturing fluid, as a non-limiting example, is prepared by blending a VES into an aqueous fluid. The aqueous fluid could be, for example, water, brine, seawater, and the like. Any suitable mixing apparatus may be used for this procedure. In the case of batch mixing, the VES and the aqueous fluid are blended for a period of time sufficient to form a gelled or viscosified solution. The stabilizers or solubility agents may be added at the time the VES fluid is prepared, or alternatively, the stabilizers or solubility agents compositions herein may be added separately, before or after the VES is added.

Propping agents are typically added to the base fracturing fluid after the addition of the VES. Propping agents include, but are not limited to, for instance, quartz sand grains, glass and ceramic beads, bauxite grains, walnut shell fragments, aluminum pellets, nylon pellets, and the like. The propping agents are normally used in concentrations between about 1 to 14 pounds per gallon (120-1700 kg/m³) of fracturing fluid composition, but higher or lower concentrations can be used as the fracture design required. The base fluid can also contain other conventional additives common to the well service industry such as water wetting surfactants, non-emulsifiers, biocides, clay control agents, pH buffers, fluid loss additives, enzymes, and the like, which are not necessarily part of the microemulsion. As noted, in this invention, the base fluid can also contain other non-conventional additives which can contribute to the various functions described, and which are added for those purposes.

In a typical fracturing operation, the fracturing fluid of the invention is pumped at a rate sufficient to initiate and propagate a fracture in the formation and to place propping agents into the fracture. A typical fracturing treatment would be conducted by mixing a 20.0 to 60.0 gallon/1000 gal water (volume/volume—the same values may be used with any SI volume unit, e.g. 60.0 liters/−1000 liters) amine oxide VES, such as SurFRAQ, in a 3% (w/v) (249 lb/1000 gal, 29.9 kg/M³) KCl solution at a pH ranging from about 6.0 to about 9.0. Any breaking components are added after the VES addition, or in a separate step after the fracturing operation is complete or in some cases with the VES-gelled fluid.

In one embodiment, the method is practiced in the absence of gel-forming polymers and/or gels or aqueous fluid having their viscosities enhanced by polymers and/or crosslinked polymers.

The present invention will be explained in further detail in the following non-limiting Examples that are only designed to additionally illustrate the invention but not narrow the scope thereof.

### GENERAL PROCEDURE FOR EXAMPLES 1-16

To a blender were added tap water, 10.8 ppg (1.3 kg/liter) density CaCl₂, followed by 4 vol % amine oxide viscoelastic surfactant of FIGS. 1 and 2, along with 6.0 pptg (0.24 kg/M³) (unless otherwise specified) of VES-STA 1 stabilizer available from Baker Oil Tools. The blender was used to mix the components on a very slow speed, to prevent foaming, for about 30 minutes to viscosity the VES fluid. The indicated additional polyol or glycol stabilizers were added (if present). The mixed samples were then placed into plastic bottles.

The viscosity change (generally reduction) can be visually detected by heating the fluids within a water bath to approximately 200° F. (93° C.) under atmospheric conditions. Shaking the samples and comparing the elasticity of gel and rate of air bubbles rising out of the fluid can be used to estimate the amount of viscosity reduction observed using the water bath method. Measurements using a Grace 5500 rheometer at 100 sec⁻¹ shear, at 250° F. (121° C.) with 300 psi (2.1 MPa) pressure were also used to acquire quantitative viscosity reduction of each sample.

### EXAMPLES 1-10

As shown in FIG. 1, Baseline Example 1 contains no added stabilizer and serves as a reference against which the performance of the other stabilizers is measured. The various stabilizers are given in Table I.

TABLE I
Stabilizers for Examples 1–10

| Example | Stabilizer and proportion |
|---|---|
| 1 | none - baseline |
| 2 | 0.5 vol % glycerol |
| 3 | 0.5 vol % MPG |
| 4 | 0.5 vol % DPG |
| 5 | 0.5 vol % TPG |
| 6 | 0.5 vol % MEG |
| 7 | 0.5 vol % DEG |
| 8 | 0.5 vol % TEG |
| 9 | 0.5 vol % TetraEG |
| 10 | 0.5 vol % PolyPG 425 |
| | (weight average molecular |
| | weight of 425) |

From the viscosity data in FIG. 3, it may be seen that the formulations of Examples 3, 5, 6, 7, 8, and 9 all performed better than the baseline Example 1. Once the fluids of Examples 5 and 4 reached a lower viscosity level after about 0.5 hour, they were remarkably stable. The polypropylene glycol of Example 10 did not perform well, and the glycerol of Example 2 was below the baseline of Example 1.

### EXAMPLES 11-13

FIG. 4 presents further Examples of how MPG may serve as an effective stabilizer for the amine oxide VES-gelled fluids herein. Example 11 of the lowest, poorest curve is the Batch 6 material with no MPG added and it may be seen that the viscosity diminishes quickly over 10 hours. Example 12 is a curve of the Batch 6 material with 0.5 vol % MPG and the viscosity is maintained noticeably better before declining after about 3 hours. Example 13 using the Batch 6 material together with 1.0 vol % MPG gives the best curve shown in FIG. 4 showing that the viscosity is maintained for a significant time.

### EXAMPLE 14

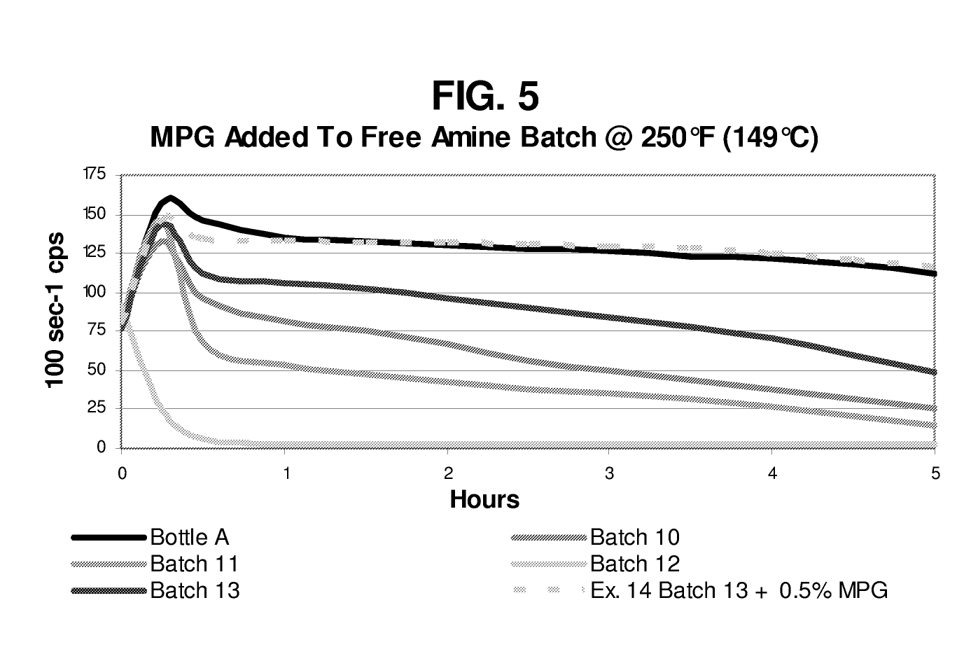

Shown in FIG. 5 is the curve resulting from Example 14 using the Batch 13 material together with 0.5 vol % MPG. Indeed, FIG. 5 is identical to FIG. 2 except for the additional curve of Example 14 which shows significant improvement over the Batch 13 curve simply by adding the MPG. In fact, the Example 14 viscosity curve is essentially the same as the baseline curve for Bottle A demonstrating that the stabilizers of this invention may restore the viscosity performance to what it should be for the amine oxide VES-gelled fluids.

As used herein, the word “comprising” as used throughout the claims is to be interpreted to mean “including but not limited to”.

In the foregoing specification, the invention has been described with reference to specific embodiments thereof, and has been demonstrated as effective in providing methods and compositions for improving the ability of VES-gelled fluids to maintain their viscosity, in one non-limiting embodiment. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of viscoelastic surfactants, stabilizers, solubilizing agents, solvents, hydrotropes, co-surfactants, desorption agents, water wetting agents, dispersing agents, water hardness agents, demulsifier agents, and other components falling within the claimed parameters, but not specifically identified or tried in a particular composition or fluid, are anticipated to be within the scope of this invention.

What is claimed is:

1. A method for stabilizing an aqueous fluid gelled with a viscoelastic surfactant (VES), the method comprising combining in any order:
water;
a VES in an amount effective to increase the viscosity of the fluid; and
a stabilizer selected from the group consisting of glycols and polyols, where the stabilizer is present in an amount effective to substantially maintain the increased viscosity of the water gelled with VES.

2. The method of claim 1 where the VES comprises a glycol solvent different than the stabilizer.

3. The method of claim 1 where the stabilizer is at least 95% pure glycol or polyol.

4. The method of claim 1 where in the stabilizer the glycols are selected from the group consisting of monoethylene glycol, diethylene glycol, triethylene glycol, tetraethylene glycol, monopropylene glycol, dipropylene glycol, and tripropylene glycol, and where the polyols are selected from the group consisting of polyethylene glycol, polypropylene glycol, and glycerol, and mixtures thereof.

5. The method of claim 4 where the stabilizer is at least 95% pure glycol or polyol.

6. The method of claim 1 where the effective amount of stabilizer ranges from about 0.1 to 10.0% by volume based on the total of the aqueous fluid.

7. The method of claim 1 where the increased viscosity of the aqueous fluid is substantially maintained over a temperature range of from about ambient to about 300° F. (about 149° C.).

8. A method for stabilizing an aqueous fluid gelled with a viscoelastic surfactant (VES), the method comprising:
providing the gelled aqueous fluid, where the fluid comprises:
water; and
a VES in an amount effective to increase the viscosity of the fluid, where the VES comprises a glycol solvent; and
adding a stabilizer to the gelled aqueous fluid selected from the group consisting of glycols and polyols, where the stabilizer is present in an amount effective to substantially maintain the increased viscosity of the water gelled with VES.

9. The method of claim 8 where the stabilizer amount ranges from about 0.1 vol % to about 10.0 vol % based on the total of the aqueous fluid.

10. The method of claim 8 where in the stabilizer is at least 95% pure glycol or polyol, and the glycols are selected from the group consisting of monoethylene glycol, diethylene glycol, triethylene glycol, tetraethylene glycol, monopropylene glycol, dipropylene glycol, and tripropylene glycol, and where the polyols are selected from the group consisting of polyethylene glycol, polypropylene glycol, and glycerol, and mixtures thereof.

11. The method of claim 8 where the increased viscosity of the aqueous fluid is substantially maintained over a temperature range of from about ambient to about 300° F. (about 149° C.).

12. A gelled, stabilized aqueous fluid comprising:
water;
a viscoelastic surfactant (VES) in an amount effective to increase the viscosity of the water; and
a stabilizer selected from the group consisting of glycols and polyols, where the stabilizer is present in an amount effective to substantially maintain the increased viscosity.

13. The fluid of claim 12 where the VES comprises a glycol solvent different than the stabilizer.

14. The fluid of claim 12 where the stabilizer is at least 95% pure glycol or polyol.

15. The fluid of claim 12 where the glycols are selected from the group consisting of monoethylene glycol, diethylene glycol, triethylene glycol, tetraethylene glycol, monopropylene glycol, dipropylene glycol, and tripropylene glycol, and where the polyols are selected from the group consisting of polyethylene glycol, polypropylene glycol, and glycerol, and mixtures thereof.

16. The fluid of claim 15 where the stabilizer is at least 95% pure glycol or polyol.

17. The fluid of claim 12 where the effective amount of stabilizer ranges from about 0.1 to 10.0% by volume based on the total of the aqueous fluid.

18. The fluid of claim 12 where the increased viscosity of the aqueous fluid can be substantially maintained over a temperature range of from about ambient to about 300° F. (about 149° C.).

19. A method of fracturing a subterranean formation comprising injecting a fracturing fluid through a wellbore at sufficient pressure to fracture the formation, where the fracturing fluid is the gelled, stabilized aqueous fluid of claim 12.

20. A gelled, stabilized aqueous fluid comprising:
water;
a viscoelastic surfactant (VES) in an amount effective to increase the viscosity of the water; and
a stabilizer selected from the group consisting of glycols and polyols where the glycols are selected from the group consisting of monoethylene glycol, diethylene glycol, triethylene glycol, tetraethylene glycol, monopropylene glycol, dipropylene glycol, and tripropylene glycol, and where the polyols are selected from the group consisting of polyethylene glycol, polypropylene glycol, and glycerol, and mixtures thereof, where the stabilizer is present in an amount ranging from about 0.1 to 10.0% by volume based on the total of the aqueous fluid.

21. The fluid of claim 20 where the stabilizer is at least 95% pure glycol or polyol.
